(19) United States
(12) Patent Application Publication
(10) Pub. No.: US 2026/0228704 A1
(43) Pub. Date: Aug. 6, 2026

(54) INTERACTIVE ARTIFICIAL INTELLIGENCE ASSISTANT TO SUPPORT COMPLEX HUMAN-DRIVEN MULTI-STEP INTERACTIONS

(71) Applicant: The Johns Hopkins University, Baltimore, MD (US)

(72) Inventors: Brendan P. McNelly, Ellicott City, MD (US); Blake A. Schreurs, Columbia, MD (US); Francisco J. Aldarondo Valle, Columbia, MD (US); Aakash Bajpai, Atlanta, GA (US); Michael W. Hannan, Woodbine, MD (US)

(73) Assignee: The Johns Hopkins University, Baltimore, MD (US)

(21) Appl. No.: 19/308,206

(22) Filed: Aug. 23, 2025

Related U.S. Application Data
(60) Provisional application No. 63/752,703, filed on Feb. 1, 2025.

(51) Int. Cl. G06Q 10/20; G06N 3/047; G06T 19/00

(52) U.S. Cl. CPC G06Q 10/20; G06N 3/047; G06T 19/006

(57) ABSTRACT

A system for providing agentic AI-assisted complex processing, troubleshooting or repair includes a documents agent including storage for a plurality of repair procedures, an AI manager including a state machine defining a plurality of states through which diagnostic processes relating to the troubleshooting or repair are managed in relation to a selected repair procedure among the plurality of repair procedures, a data analytics agent including a Bayesian Network model that produces an assessment, an AI agent including one or more AI models, and an AI manager including a HMI module configured to enable an operator or group of operators to interface with the data analytics agent via natural language interaction with the AI agent to drive a process for the troubleshooting or repair of a device associated with the selected repair procedure.

### CROSS-REFERENCE TO RELATED APPLICATIONS

This application claims priority to and the benefit of U.S. Provisional Application No. 63/752,703 filed on Feb. 1, 2025, the entire contents of which are hereby incorporated herein by reference.

### TECHNICAL FIELD

Example embodiments generally relate to techniques for employing agentic artificial intelligence (AI) and large language models (LLM) in an integrated way to assist in human-driven interactions such as repair activities.

### BACKGROUND

From our homes and cars all the way to the massive complexity of ships at sea, much of the enabling technology of modern society requires a system of routine maintenance and repair in order to function effectively over time. These systems require the existence of highly skilled technicians that are specifically trained to solve problems, diagnose issues, and engage in troubleshooting and repair with respect to these complex systems. Artificial Intelligence (AI) Assistants powered by advanced statistical methods and Large Language Models (LLMs) allow less experienced individuals to perform maintenance and repair tasks on complex, specialized systems at a level comparable to that of highly trained technicians.

Prior work in this area has focused on using visual cues to issue commands through human interaction with an AI expert operating in a fixed or predefined context. This approach may allow guidance within that static context but lacks the flexibility to adapt based on new information provided during a session. In contrast, the example embodiments aim to improve this capability by providing real-time troubleshooting capabilities and repair that is fully interactive and dynamic in terms of its ability to coordinate and manage interactions through a dialog with the system.

### BRIEF SUMMARY

In one non-limiting, example embodiment, a system for providing agentic AI-assisted troubleshooting or repair may be provided. The system may include a documents agent including storage for a plurality of repair procedures, an AI manager data analytics agent including a state machine defining a plurality of states through which diagnostic processes relating to the troubleshooting or repair are managed in relation to a selected repair procedure among the plurality of repair procedures, a data analytics agent including a Bayesian Network model that produces an assessment, an AI agent including one or more AI models, and an AI manager including a HMI module configured to enable an operator or group of operators to interface with the data analytics agent via natural language interaction with the AI agent to drive a process for the troubleshooting or repair of a device associated with the selected repair procedure.

In another example embodiment, an artificial intelligence (AI) manager for providing agentic AI-assisted troubleshooting or repair may be provided. The AI manager may include a human machine interface (HMI) module and processing circuitry including a processor and memory that are configured to interface with a documents agent including storage for a plurality of repair procedures, a data analytics agent including a state machine defining a plurality of states through which diagnostic processes relating to the troubleshooting or repair are managed in relation to a selected repair procedure among the plurality of repair procedures, and an AI agent including one or more AI models. The HMI module may be configured to enable an operator or group of operators to interface with the data analytics agent via natural language interaction with the AI agent to drive a process for the troubleshooting or repair of a device associated with the selected repair procedure.

### BRIEF DESCRIPTION OF THE SEVERAL VIEWS OF THE DRAWING(S)

Having thus described some example embodiments in general terms, reference will now be made to the accompanying drawings, which are not necessarily drawn to scale, and wherein:

FIG. 1 illustrates a functional block diagram of a system for providing agentic AI-assisted troubleshooting or repair with external network connectivity according to an example embodiment;

FIG. 2 illustrates a block diagram of a variant of the system of FIG. 1 in which network connectivity is omitted according to an example embodiment;

FIG. 3 illustrates a block diagram of a state machine structure and various actions associated therewith in accordance with an example embodiment;

FIG. 4 shows a basic structure for one level of a Bayesian network in accordance with an example embodiment;

FIG. 5 illustrates a block diagram of an AI manager operably coupled to an advanced manufacturing device in accordance with an example embodiment;

FIG. 6 shows a block diagram of components and capabilities of the advanced manufacturing device in accordance with an example embodiment; and

FIG. 7 illustrates a block diagram of an incorporation of augmented reality and session recording in accordance with an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. As used herein, operable coupling should be understood to relate to direct or indirect connection that, in either case, enables functional interconnection of components that are operably coupled to each other. Like reference numerals refer to like elements throughout.

As noted above, the advent of AI tools based on LLMs have enabled new ways for humans to interact with documentation and complex data analytics environments. Other technologies, like augmented reality (AR) have also been developed extensively in recent years. However, it has not been experienced to date that an integration of AI, AR, and data analytics capabilities could be employed in enhancing human-driven processes, such as diagnostics and repair. Although AI and AR have been integrated together for teleoperation, conversion of natural language to code, and gaming, those integrations were not inclusive of and influenced by real-time data analytics. Meanwhile, example embodiments may integrate AI, AR and data analytics to further employ unique data processing and presentation tools that further enhance the interaction with human operators for working through complex processes such as, for example, troubleshooting and repair activities.

Example embodiments may therefore provide integrated technologies that provide operators with a user-friendly means of accessing appropriate documentation, analytics about a process or system under test, and clearly defined steps, all while interacting using natural human language. Accordingly, instead of relying on highly trained and experienced experts, who develop that expertise over long periods of time, and often costly training, much more basically trained technicians can tackle complex processes using the example embodiments. Moreover, example embodiments provide a technological tool for providing these technicians with real-time guidance that can itself be updated rapidly and in real time or near real time. Instead of sifting through massive amounts of information or data, or developing a familiarity with such bodies of information over long periods, situational awareness and detailed real time guidance can be provided to the user for even new or rapidly changing processes. Example embodiments may also enable logging of information or recording thereof in a format that is effectively invisible to the user, since interactions and process completion can be recorded for re-use or visualization later on, and/or (re) training models.

Of note, although any complex user-driven process with multiple steps may benefit from example embodiments, certain tasks and processes may be especially well suited to enhancement via integration of the technologies described herein. For example, assembly and disassembly of hardware, standard maintenance, troubleshooting and repair of equipment and machinery, repair of failed machinery or components, and process driven practices such as checkups or other maintenance activities may all experience huge improvements by implementing example embodiments. This list clearly suggests industrial applicability across a wide range of industries including automotive, aerospace, and the trades in general. However, one particular area of application that may be beneficial may be the military.

In this regard, for example, the military routinely enlists junior soldiers, sailors and airmen that are expected to perform maintenance and repair activities in one or more operational tours of duty. However, many of the individuals challenged with learning the corresponding tasks that support these maintenance and repair activities will go on to other duties or leave the military, and thereby create an endless stream of needed trainees to continue the tasks into the future. Meanwhile the equipment they work on may continue to be upgraded or replaced, necessitating new training that is costly to continue. Providing tools to expedite and enhance training and, in any case, increase productivity and reliability of work performed with less training would therefore be of huge advantage. But the advantage does not stop there. Ships and other relatively large assets or military activities that deploy overseas are often required to take on large stores of repair parts and tools, not to mention the large volumes of data and manuals needed to provide information for storing, locating, and then replacing/repairing various components. Instead, a smaller set of highly capable tools and materials could be taken on deployment so that components could be repaired and even manufactured on deployment in short times and with high reliability using technology, doing so may be a game changer. Example embodiments may provide just such technology and tools.

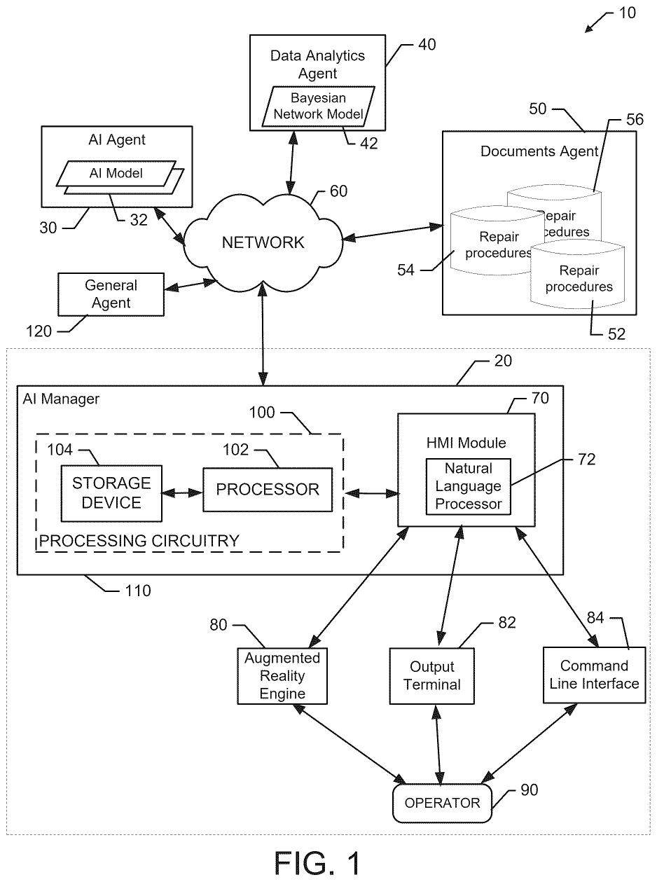

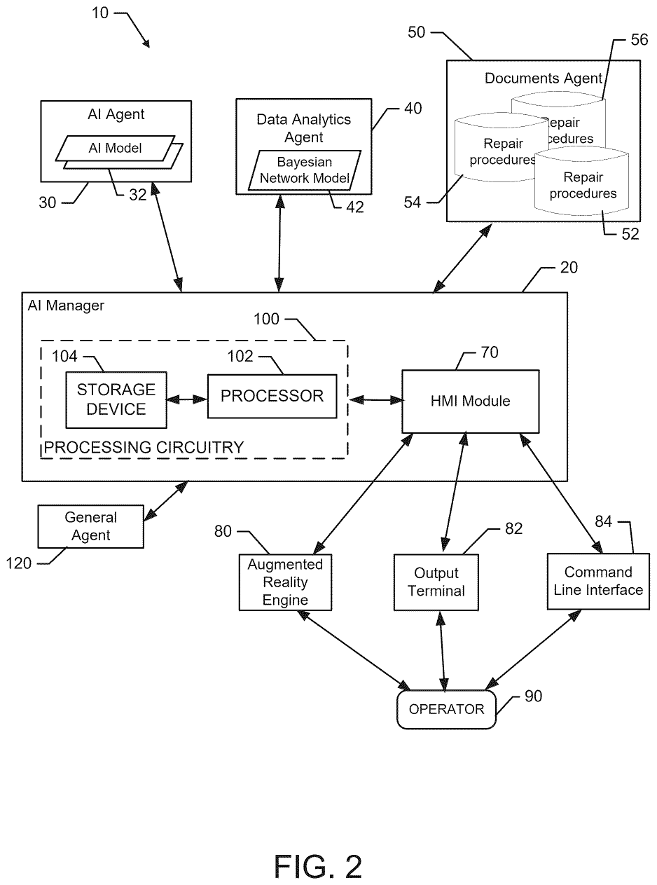

FIG. 1 illustrates a system 10 for providing agentic AI-assisted troubleshooting or repair according to an example embodiment. However, it should be appreciated that example embodiments may also be applied to activities beyond troubleshooting and repair, and thus that particular application is merely one non-limiting example of an area in which example embodiments may be useful. The system 10 may include an AI manager 20, which may be operably coupled to an AI agent 30, a data analytics agent 40, and a documents agent 50. In some cases, the AI manager 20 may further be operably coupled to additional agents that may have various functions. In FIGS. 1 and 2, an example of such an additional agent is represented by general agent 120. The general agent 120 may represent, among other things, external application programming interfaces (APIs), robotic control platforms, web services, etc., and may provide additional resources for the AI manager 20 to leverage via interaction therewith for completion of respective tasks. Each of the respective agents may include or be embodied at respective instances of processing circuitry, which may include processors, memory devices and other computing device hardware such as computers, servers, or the like.

The AI agent 30 may include one or more instances of an AI model 32. The AI model 32 may include statistical models, foundation models (FMs), vision language models (VLMs), large language models (LLMs), and/or the like, which are employed in an agentic scheme to enhance interactivity with humans. The AI model 32 may be or include, for example, a generative pre-trained transformer (GPT) such as Open AI's GPT-4®, or various other GPTs including especially those that employ reinforcement learning human feedback (RLHF). Although not required, in some cases, the AI model 32 may be specifically trained on context specific information associated with the troubleshooting and repair context in which the AI agent 30 is expected to be employed. Thus, for example, the AI agent 30 may be trained on a ship maintenance context involving a plurality of classes of ships. Moreover, in some cases, the AI agent 30 may be trained only on a specific class of ships, or even a specific ship in a class of ships. Similar types of context specific training, in other context situations may also be employed for other system employment scenarios.

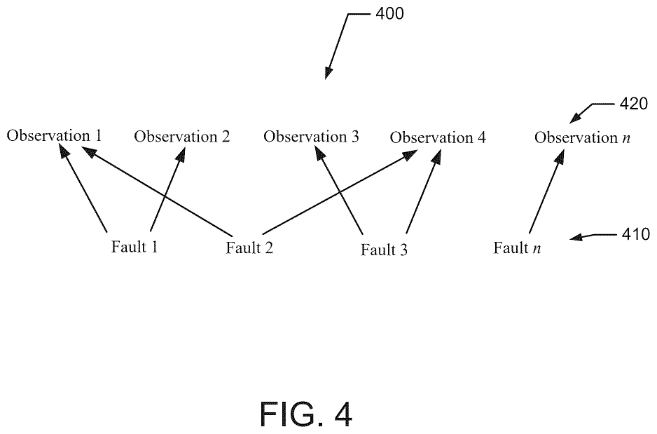

The data analytics agent 40 may include a Bayesian network model 42, which may be a Bayesian inference model 400 (see FIG. 4) that correlates various faults 410 to corresponding indications or observations 420 that may be associated with the fault. For example, failure of a particular LED on a board to light (i.e., an example observation) may be associated with faults that may include power switch failure, failure of wiring in or leading to the LED, or various other conditions that would interrupt power to the LED. However, numerous other faults that are unrelated to the LED receiving power or otherwise lighting up may be excluded from being related to the corresponding observation in the Bayesian network model 42. Notably, it should be appreciated that the Bayesian network model 42 is merely one example of a predictive analytics tool that may be used by example embodiments. Other predictive analytics tools may be substituted for the Bayesian network model 42 in alternative embodiments. Operation of the Bayesian network model 42 in connection with the system 10 will be described in greater detail below in reference to FIG. 4.

The documents agent 50 may include a repository for documents that are useful for the particular context in which example embodiments are practiced. A technique such as Retrieval Augmented Generation (RAG) or other related approaches can be used to retrieve the relevant information stored in the documents. In an example embodiment in which troubleshooting and repair are employed, the documents agent 50 may store documentation associated with repair procedures, which may further include diagnostic procedures that define troubleshooting processes needed to identify faulted components based on observable phenomenon (e.g., observations). In some cases, the documents agent 50 may store documentation associated with multiple different systems, pieces of equipment, components, or the like. Thus, for example, the documents agent 50 may include storage for first repair procedures 52 associated with a first system or piece of equipment, second repair procedures 54 associated with a second system or piece of equipment, third repair procedures 56 associated with a third system or piece of equipment, and any additional number of repair procedures as desired.

In some example embodiments, the first repair procedures 52 may be exclusively associated with one equipment piece or system that is entirely different in type and context to the equipment or system that is associated with the second repair procedures 54 (and the third repair procedures 56). Thus, for example, the first repair procedures 52 may be associated with weapons systems of a ship, and the second repair procedures 54 may be associated with electrical power production systems of the ship. The third repair procedures 56 may be associated with steam production systems of the ship, and so on until every system of the ship is covered by its own respective set of repair procedures. However, in other cases, the different sets of repair procedures may be distinguished based on versions of a system that is otherwise very similar, such that, for example, more modern and antiquated versions are each covered separately by the first, second and third repair procedures 52, 54 and 56.

The AI manager 20 may be operably coupled to the AI agent 30, the data analytics agent 40 and the documents agent 50 via a network 60 in some cases. The network 60 may be instantiated via a wired interconnection (e.g., Ethernet, local area network (LAN), wide area network (WAN) such as the Internet, or the like), or a wireless interconnection (e.g., 5G wireless, other cellular technologies, satellite communication, WIFI®, BLUETOOTH®, proprietary wireless protocols, etc.). In the ship context noted above, the network 60 may be a satellite communication network when the ship is at sea, or any other wireless or wired connection when the ship is in port. When provided or otherwise available, connection to the Internet by the AI manager 20 may enable the AI manager to search any documentation that is available online or “in the cloud.” Moreover, the AI manager 20 may itself be considered to be located in the cloud in some cases, and be interacted with as a service accessed in the cloud. In any case, the AI manager 20 may be enabled to interact with any agent as long as there is an API available (i.e., thereby not limiting connection to only those agents specifically shown). As an example, the AI manager 20 may be supplied with database APIs.

However, in some cases, the network 60 may be omitted, as shown in FIG. 2, and the AI agent 30, the data analytics agent 40 and the documents agent 50 may each be directly operably coupled to the AI manager 20. It should also be noted that connections may vary between the respective agents, such that some of the agents have wired connection to the AI manager 20 and others have wireless connections, which can be the same or different from each other. Moreover, in some cases, portions of the AI agent 30, the data analytics agent 40 and the documents agent 50 may be distributed across different platforms such that, for example, when connectivity (wired or wireless) is possible, distributed portions of the AI agent 30, the data analytics agent 40 and the documents agent 50 that are accessible via the network 60 are employed and, when connectivity (wired or wireless) is not possible, distributed portions of the AI agent 30, the data analytics agent 40 and the documents agent 50 that are local and collocated with the AI manager 20 are employed.

The AI manager 20 may include a human machine interface (HMI) module 70 that enables the AI manager 20 to interface with a plurality of different input and/or output devices. In this regard, for example, the HMI module 70 may be operably coupled to one or more instances of an augmented reality engine 80 (or more generally, an extended reality engine), an output terminal 82, and a command line interface 84 that enable an operator 90 to interface with the AI manager 20 to manage complex task completion using different interaction modes. Regardless of which of the input/output devices is used, the operator 90 may select a desired interaction mode and corresponding input/output device to support the selected mode. It should be noted that in some cases multiple instances of each particular type of input/output device may be used to support parallel operations by multiple technicians simultaneously. Thus, for example, rather than having only a single augmented reality engine 80, the HMI module 70 may be operably coupled to multiple augmented reality engines and, for example, each augmented reality engine may be employed simultaneously by respective different technicians performing troubleshooting and/or repair on either a same or different type or piece of equipment.

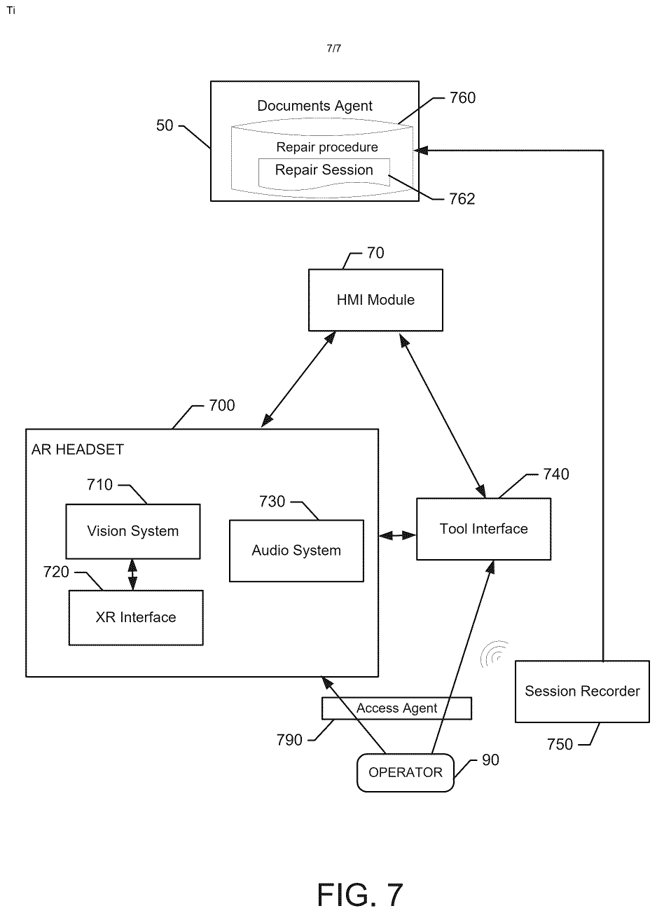

The augmented reality engine 80 may include hardware and software associated with defining an augmented reality interface for the operator 90 to interact with the device or system under test in an augmented reality environment and/or project information on a holographic (or other extended reality (XR)) interface to guide a user and/or track what actions a user has made for updating of the AI or other agents. Thus, for example, the augmented reality engine 80 may enable the operator 90 to view holographic images overlaid onto the device or system under test in order to guide the operator 90 to perform specific tasks with respect to the device or system under test. The augmented reality engine 80 may therefore require additional hardware (e.g., goggles, hologram generation equipment, etc.) that further enables the interaction with the operator 90, some of which will be described in greater detail below in reference to FIG. 7. However, in any case, the purpose of the augmented reality tool is to demonstrate observable phenomena that can be compared to current observations for troubleshooting and/or to demonstrate specific repair activities (and their ordering and nuanced instruction for performance) that are to be performed by the operator 90 during a repair session.

The output terminal 82 may be a computer terminal or client (e.g., desktop, tablet, mobile device, web browser, laptop computer, or the like) having various graphical interface icons, menus, images, videos and/or the like. Thus, for example, the operator 90 may sit at the output terminal 82 and call up images or videos that demonstrate scenarios that can be compared to current observations to assist in troubleshooting. The images or videos may also include aspects or scenes relating to the repair activities through which the operator 90 is to be guided during a repair session.

The command line interface 84 meanwhile provides a text-based way to interact with the operating system of the AI manager 20. However, text-to-speech (and speech-to-text) may also be integrated into the command line interface 84. In any case, however, rather than using graphical interface elements such as images, videos, icons or menus, the command line interface 84 may provide an entirely text or speech (e.g., conversational) interface means for the operator 90 to interact with the AI manager 20. Generally speaking, the AI manager 20 may include modules that permit input and output via natural language interactions for audio (speed/voice/listening), visual (inspecting, projecting and tracking), and text-based interactions. The natural language employed may be conversational and cover various responses so that, for example, a light being on could be understood as corresponding to being either on, lit, active, working, valid, functional or the like, in a conversational context.

Example embodiments may be instantiated with any or all of the augmented reality engine 80, the output terminal 82 and the command line interface 84 (including potentially multiple instances of each). Thus, for example, the operator 90 may select a preferred mode of interaction for beginning a repair session with the AI manager 20, and may use a corresponding interface tools to achieve desired results. Accordingly, if the operator 90 prefers to see an augmented reality guide through troubleshooting and/or repair of the device or system under test, the operator 90 may engage and use the augmented reality engine 80. If instead, the operator 90 would like to see menus, icons, images or videos that demonstrate aspects of the troubleshooting and/or repair procedures that will be associated with a repair session, the operator 90 may engage and use the output terminal 82, which could be displayed on an interactive tablet interface. As yet another alternative, if the operator 90 prefers to have conversational interaction and/or guidance on a text or speech basis, the command line interface 84 option may be employed.

It is noteworthy that some example embodiments may be implemented with only one (or two) of the three optional interfaces described herein. Moreover, in some cases, the operator 90 (or multiple operators) may choose to interact with multiple different ones of the optional interface means described herein either sequentially or simultaneously. Thus, for example, the operator 90 (or multiple operators) may engage in a text based interaction with the AI manager 20 while simultaneously also viewing images or videos via the output terminal 82.

The AI manager 20 may include or otherwise be embodied by execution of software by hardware hosting such software. Thus, for example, the AI manager 20 may include processing circuitry 100, which may include one or more instances of a processor 102 and storage device 104 (e.g. memory). The HMI module 70 may, in some cases, also be instantiated via software, which may operate on the hardware of the AI manager 20. Thus, for example, the HMI module 70 may be instantiated by software application stored in the storage device 104 responsive to execution by the processor 102 of the processing circuitry 100.

In an example embodiment, the storage device 104 may include one or more non-transitory storage or memory devices such as, for example, volatile and/or non-volatile memory that may be either fixed or removable. The storage device 104 may be configured to store information, data, applications, instructions or the like for enabling the apparatus to carry out various functions in accordance with example embodiments. For example, the storage device 104 could be configured to buffer input data for processing by the processor 102. Additionally or alternatively, the storage device 104 could be configured to store instructions for execution by the processor 102. As yet another option, the storage device 104 may include one of a plurality of databases that may store a variety of files, contents or data sets, or structures used to embody the HMI module 70. Moreover, in some cases, the storage device 104 may include some portion that stores the repair procedures of the documents agent 50, as well as software applications associated with execution or operation that, when executed by the processor 102, instantiates the AI agent 30 and/or the data analytics agent 40 on the hardware platform that constitutes the AI manager 20. Thus, for example, the storage device 104 may also store one or more neural networks (e.g., a convolutional neural network (CNN) or other machine learning tools) capable of performing machine learning for applications associated with diagnosing observations in terms of the faults they may correlate to. Thus, in general terms, among the contents of the storage device 104, various applications may be stored for execution by the processor 102 in order to carry out the functionality associated with each respective application.

The processor 102 may be embodied in a number of different ways. For example, the processor 102 may be embodied as various processing means such as a microprocessor or other processing element, a coprocessor, a controller or various other computing or processing devices including integrated circuits such as, for example, an ASIC (application specific integrated circuit), an FPGA (field programmable gate array), a hardware accelerator, or the like. In some cases, the processor 102 may be embodied as, or otherwise include, a graphics processing unit (GPU) to provide robust processing capability that may be needed to handle the large processing loads associated with employing AI tools and data analytics in combination with augmented reality interactions for real time execution. In an example embodiment, the processor 102 may be configured to execute instructions stored in the storage device 104 or otherwise accessible to the processor 102. As such, whether configured by hardware or software methods, or by a combination thereof, the processor 102 may represent an entity (e.g., physically embodied in circuitry) capable of performing operations according to embodiments while configured accordingly. Thus, for example, when the processor 102 is embodied as an ASIC, FPGA, GPU or the like, the processor 102 may be specifically configured hardware for conducting the operations described herein. Alternatively, as another example, when the processor 102 is embodied as an executor of software instructions, the instructions may specifically configure the processor 102 to perform the operations described herein.

In an example embodiment, the processor 102 (or the processing circuitry 100) may be embodied as, include or otherwise control HMI module 70, and perhaps also one or more of the AI agent 30, the data analytics agent 40 and the documents agent 50, each of which may be any means such as a device or circuitry operating in accordance with software or otherwise embodied in hardware or a combination of hardware and software (e.g., processor 102 operating under software control, the processor 102 embodied as an ASIC, FPGA, or GPU specifically configured to perform the operations described herein, or a combination thereof) thereby configuring the device or circuitry to perform the corresponding functions of the HMI module 70 and/or the AI agent 30, the data analytics agent 40 and the documents agent 50, respectively, as described herein. It should be appreciated that the processing circuitry 100 (and AI manager 20 more generally) may be setup to store and/or operate on classified or unclassified information. Accordingly, security, encryption, authorization, validation, and/or other techniques for protecting information, when needed, may also be employed.

As noted above, in the example of FIG. 2, the AI manager 20 may be collocated with the AI agent 30, the data analytics agent 40 and the documents agent 50, and further also with one or more instances of the augmented reality engine 80, the output terminal 82, and the command line interface 84. This arrangement may enable, for example, off-line troubleshooting and repair on a ship deployed at sea, or at other locations where internet connectivity is unavailable or otherwise not desired for use. In such cases, the FMs of the AI model 32 may be trained specifically for the context in which the AI manager 20 is expected to be deployed.

Alternatively, as shown in FIG. 1, the AI manager 20, along with its devices for interface with the operator 90 (e.g., the augmented reality engine 80, the output terminal 82, and the command line interface 84) may all be located on a single platform 110 (e.g., a ship or industrial facility), and the network 60 may be used to provide connectivity to the AI agent 30, the data analytics agent 40 and the documents agent 50. Such connectivity may be persistent (e.g., available at all (or virtually all) times), or may be provided only when actively required. Thus, for example, when the single platform 110 is a ship in port, wired or wireless connectivity from the single platform to the AI agent 30, the data analytics agent 40 and the documents agent 50 may be provided via the network 60. However, when the single platform 110 is a ship at (or under) the sea, the network 60 may be only periodically used (e.g., via satellite communication) to establish connectivity to the AI agent 30, the data analytics agent 40 and the documents agent 50.

In some examples, the AI agent 30, the data analytics agent 40 and the documents agent 50 may be provided on one platform (e.g., a ship or repair facility), and the AI manager 20 may be provided on another (e.g., the single platform 110) such that connectivity is provided as needed between platforms either when proximity is established (e.g., the single platform 110 pulling alongside a repair ship or pier nearby the ship or repair facility). However, the flexible nature of the network 60 in terms of providing wireless communication, including satellite communication, means that proximity is not a limiting factor in relation to operation of example embodiments.

As can be appreciated from the descriptions above, the AI manager 20 may leverage an agentic framework that can incorporate various task oriented agents (e.g., the AI agent 30, the data analytics agent 40 and the documents agent 50) and expanded to cover other domains and processes. The AI manager 20 may employ a nested finite state machine to access the various agents for state-specific capabilities. In an example embodiment, the AI agent 30 may include the LLMs prompt engineering for most phases of the AI manager's 20 states. The documents agent 50 may be specifically built to generate step-by-step repair procedures from available documentation that is used during a repair phase. A retrieval augmented generation (RAG) approach may be used in connection with the documents agent 50 in some cases. But in any case, the human in the loop, i.e., the operator 90, may interact with the system via the HMI module 70 and any specific interface means that are provided.

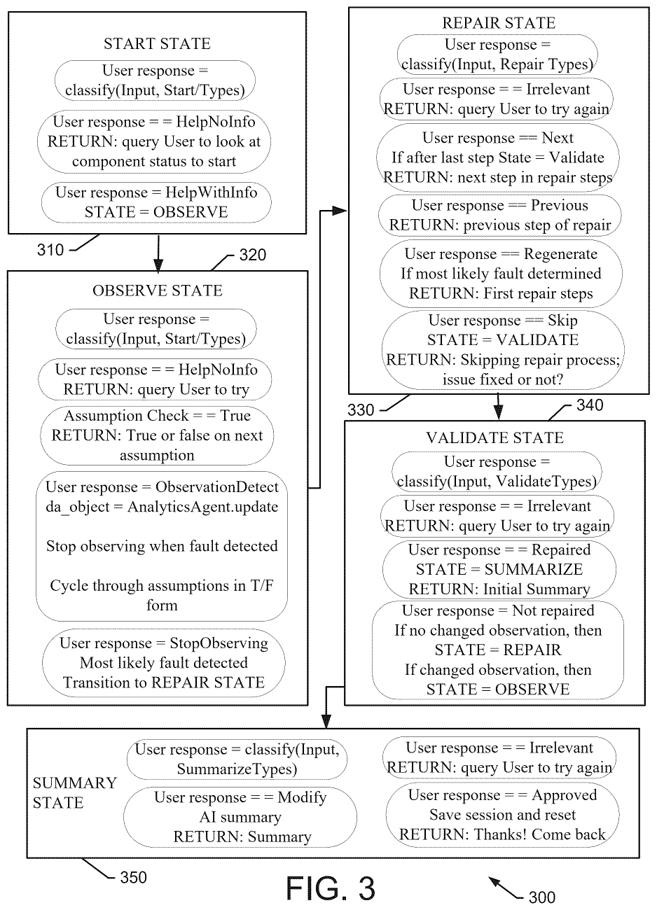

An example of the various states of a state machine 300 of an example embodiment is shown in FIG. 3. The state machine 300 itself may be instantiated at the AI manager 20 or the data analytics agent 40. The state machine 300 may define the states that guide interaction between the operator 90 and the various agents of the system 10. Thus, for example, the state machine 300 may include a start state 310, which may be used to determine initial classification information or other details that will determine what happens next in sequence, and initiates interaction with the operator 90. Thus, for example, the start state 310 may be used to identify the selected repair procedure that is to be followed (or what piece of equipment or system is the subject of a repair session). The start state 310 may be followed by an observe (or observation) state 320, a repair state 330, a validate (or validation) state 340, and a summary (or summarize) state 350. The example of FIG. 3 shows various individual examples of possible responses that the operator 90 may provide when interacting with the AI manager 20. Each possible response may trigger a transition to a different state, or further interaction within a current state. Thus, the state machine 300 effectively defines how a repair session may progress from start to finish based on the responses provided by the operator 90 to various queries generated by the AI manager 20 (based on interaction with the AI agent 30, the data analytics agent 40 and the documents agent 50).

The observe state 320 may generally include defined responses for a state during which the natural language interaction with the operator guides the operator through troubleshooting steps associated with the selected repair procedure. By providing responses to prompts issued in the observe state 320 the operator 90 may be called upon to report the status of certain indicators associated with the device or system under test (e.g., LED status, condition of components, etc.). As the operator 90 provides observations, the Bayesian network model 42 may be referenced to determine whether the observations provided can be used to identify a fault. In this regard, one observation may indicate numerous possible faults, but the operator 90 will be guided through a sequence of observations that can pin point a specific fault. Each answer or response may provide an increasing fault score (or fault confidence level) for all possible faults that remain plausible. As each subsequent observation feeds into the fault score of possible faults, the list of candidate faults may begin to be reduced to only those with fault scores (or fault confidence levels) that are above a given level. When sufficient observations have been made to enable the AI manager 20 to determine a fault with at least a predetermined threshold of confidence, a most likely fault may be determined and displayed. It may then be possible to transition to the repair state 330. Moreover, in some cases, if real-time data (e.g., diagnostic information) from the system under test is provided to the AI manager 20, the AI manager 20 may be able to update processing to determine what fault is most likely based on the data received, and then correspondingly communicate the determination and enter into the repair state 330.

The repair state 330 may be a state during which the natural language interaction with the operator guides the operator through repair steps associated with the selected repair procedure. In the repair state 330, images, charts, tables, videos, verbal directions, or augmented reality demonstrations of individual repair steps or operations may be provided. The operator 90 may be guided through the repair steps, and also asked for feedback on apparent completion or efficacy of the steps performed until the repair is ostensibly completed. Thus, for example, the operator 90 may be guided through multiple component repairs when repair of a single component does not result in overall repair of a system since troubleshooting may continue in multiple repair scenarios. When the repair is completed, the state machine 300 may transition to the validate state 340.

The validate (or validation) state 340 may be a state via which success of a repair of the device is confirmed. Thus, for example, the operator 90 may be prompted to perform various activities that may confirm whether the repair has been completed. Responsive to confirmation of the success of the repair, in some cases, the state machine 300 may transition to the summarize state 350. However, in some cases, the confirmation may not be directly indicating that the repair was successful, but instead that a particular indicator (associated with a potential positive repair) is noted. Responsive to noting the particular indication, the state machine 300 may transition back to the observe state 320 to verify observations consistent with proper operation (and therefore successful repair) of the device or system under test. Responsive to the operator 90 not confirming the success of the repair or the particular indication, the state machine 300 may transition back to the repair state 330 to repeat repair steps, or undertake different or next level repair steps that may be defined by the path that develops through further real time interaction with the operator 90 based on observations made after the first repair attempt.

The summarize state 350 may be used to summarize activities performed, and in some cases may further log information about the activities performed to the corresponding selected repair procedures that are being employed. The summarize state 350 may also be used to document key customizations of the repair process of a given repair session to assist in identifying subtle distinctions between components or pieces of equipment that may differentiate them in ways that might impact repair processes. For example a custom repair may be used for a distinct piece of equipment with a given modification previously inserted in an earlier repair operation. The custom repair may be recorded so that for any future repair activity involving that same piece of equipment, the modification may be noted and considered during future repair processes. Thus, the system 10 has the ability to improve over time and evolve as equipment status evolves. These interaction summaries could also be pooled across systems for potential foundation model (re) training and/or fine tuning.

The cooperation of the state machine 300 with actions of the data analytics agent 40 may, for example, guide the troubleshooting and repair process using the resources of the AI agent 30 and the documents agent 50. In an example embodiment, the data analytics agent 40 may define the interface by which the AI manager 20 can use the Bayesian network model 42 to assist with fault diagnostic tasks. That interface definition may include, for example, hosting and executing the state machine 300. During the observe state 320, the goal may be to collect information about the device or system under test from the operator 90 in the form of observations, which may be measurable or observable behaviors that provide evidence supporting the presence of a specific fault. Thus, the role of the data analytics agent 40 may be understood to be guiding the operator 90 through the diagnostic process based on reported observation until there is sufficient evidence to discriminate a likely fault. The data analytics agent 40 therefore may provide the AI manager 20 with capabilities for providing a list of all possible observations for a given device or system under test. The data analytics agent 40 may also provide the AI manager 20 with capabilities for returning the most likely fault provided a selection of observations, and an ultimate fault determination once a fault has been identified with sufficient confidence (i.e., above a predetermined faults score or confidence threshold). In some cases, the data analytics agent 40 may also prescribe a diagnostic test in relation to defining which observation to look for at a current stage of diagnosis (e.g., in a sequence of observations used to determine fault scoring).

Turning to FIG. 4, the graphical network representation of the Bayesian network model 42 may include a bipartite graph, where nodes represent faults 410 and observations 420. Observations will be reported by the user via interaction in order to accumulate evidence to diagnose a faulty component in the target system. In this context, faults are defective or improperly configured components that prevent the target system from functioning as expected. It is generally assumed that each separate component in a device or system under test can be a distinct fault. Moreover, there are multiple ways a component could fail. Accordingly, the system 10 may assist with respect to identifying a component that needs to be repaired, replaced or otherwise have its configuration adjusted (e.g., by connecting a loose cable or connection).

Observations 420 may be selected based on the specific hardware including a surrogate system, e.g. power indicator LEDs on or off, Ethernet port LEDs blinking or not, connector plugged in or not, etc. For example, “Component X power indicator LED is off” would provide information supporting a defective or turned off monitor, or possibly an issue with the power cable or power source. It is also possible for an observation to rule out certain faults. For example, a turned-on router provides evidence of a working power cable and power source.

To formalize the definition of the network, let F be a set of n faults, fᵢ, and let S be a set of m observations, sⱼ. A graph incidence matrix Mᵢⱼ may therefore be defined per equation (1) below:

$${M}_{ij} = \{ \begin{matrix}1 & if {s}_{j} indicates {f}_{i} , \\ - 1 & if {s}_{j} rules out {f}_{i} , \\ 0 & otherwise\end{matrix} \qquad ( 1 )$$

In order to conduct Bayesian inference over this graph, a probability distribution may be defined over the set F and S. A uniform distribution may be used to define the likelihood of each observations shown in equation (2) below, as well as the initial prior distribution over faults shown in equation (3). Conditional probability distributions are provided in equation (4)

$$P ( {s}_{j} ) = 1 / n \qquad ( 2 )$$

$$P ( {f}_{i} ) = 1 / m \qquad ( 3 )$$

$$P ( {s}_{j} \vert {f}_{i} ) = \{ \begin{matrix}0.8 & if {M}_{ij} = 1 , \\ 0.2 & if {M}_{ij} = 0 , \\ 0 & if {M}_{ij} = - 1.\end{matrix} \qquad ( 4 )$$

Each observation reported by the user adds evidence that changes the posterior distribution over the faults set. Evidence h denotes the series of observations reported so far. Posterior probabilities P′(fᵢ sⱼ|h) are computed with equations (5) and (6) below.

$${P}^{′} ( {f}_{i} \vert {s}_{j} , h ) = \frac{P ( {s}_{j} \vert {f}_{i} ) * P ( {f}_{i} \vert h )}{P ( {s}_{j} )} \qquad ( 5 )$$

$$P ( {f}_{i} \vert h ) = \frac{{P}^{′} ( {f}_{i} \vert {s}_{j} , h )}{{\sum }_{i} {P}^{′} ( {f}_{i} \vert {s}_{j} , h )} \qquad ( 6 )$$

The model outlined in equations (2)-(6) provide the means to determine the most likely faults, given a selection of observations. This will be determined by identifying the fault with the largest probability density of the current posterior values. From equation (3), provided with no observations, all faults are equally likely. If there are common fault likelihoods for a given system, they can be taken into account in initialization.

A particular repair session may be considered to include not only the diagnostic efforts that lead to a fault determination, but also the further efforts to repair the determined fault. In some example embodiments, the repair could simply be instructing the operator 90 to perform relatively simple tasks associated with performing a repair (e.g., cycling power to a device, ensuring a cable or cord is tightly connected, etc.). However, in other cases, more involved repair tasks may be instructed such as, for example, replacing a component that can be simply removed and replaced in a plug-n-play fashion. In such cases, the operator 90 may be instructed relative to which component to replace, and may be told how to affect the replacement or even provided with video or other visual instructions to assist the replacement. When replacement requires further tasks such as soldering, welding, or other adhesive or connective tasks, guidance may also be provided regarding how to conduct the corresponding further tasks. Again, step by step instructions may be demonstrated or otherwise provided to the operator 90 to assist in making the corresponding replacement or repair.

In some cases, an entire board (e.g., PCB) may need replacement. The AI manager 20 may instruct the operator 90 as to the serial number, identity, part number, and even storage location of the board that needs replacement. In other cases, a component on a board (e.g., PCB) may need replacement. The AI manager 20 may instruct the operator on the serial number, identity, part number, and even storage location of the part that needs replacement. In either case, the AI manager 20 may further demonstrate or provide instructions regarding the replacement and completion of the repair. It should also be noted that the AI manager 20 may facilitate ordering and procurement, even from external sources. For example, the AI manager 20 may have connections to external manufacturing, storage or procurement facilities to enable the operator 90 to place an order for a part that will be subject to replacement or that is being used for a repair. In these examples, it is assumed that parts (e.g., PCBs or components thereof) are stored in an accessible location. However, that may not always be the case, or even be desirable. In this regard, in some cases, rather than carry individual parts or components, it may instead be possible or desirable to carry only the capability to fabricate parts or components. This may simplify and/or reduce storage requirements, and may dramatically reduce the cost and complexity of repair activities in general.

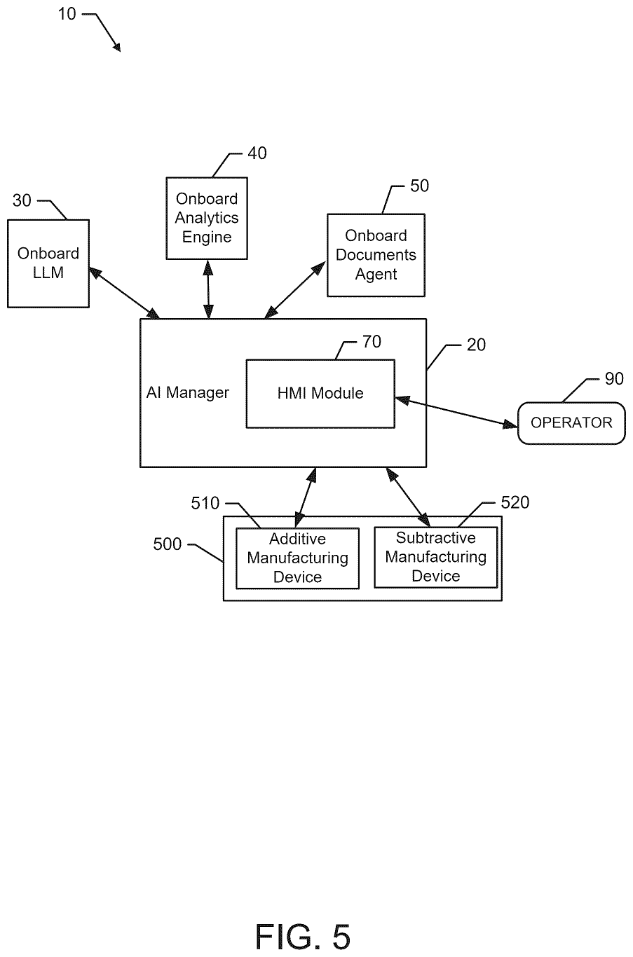

Accordingly, in some example embodiments, an advanced manufacturing device 500 may be integrated into the system 10 as shown in the example of FIG. 5. The advanced manufacturing device 500 may include one or both of an additive manufacturing device 510 and a subtractive manufacturing device 520. The additive manufacturing device 510 and the subtractive manufacturing device 520 may be implemented as separate devices, or may be integrated together into a single structure. In some embodiments, the additive manufacturing device 510 may be a 3D printer such as, for example, an aerosol jet printer. Thus, the additive manufacturing device 510 may be capable of printing very small feature sizes (e.g., down to 25 micrometer line widths). The additive manufacturing device 510 may have a motion controller with movement capability in X, Y and Z directions, interchangeable print nozzles and cassettes that may be ultrasonic or pneumatic, and an integrated shutter control. The additive manufacturing device 510 may also include a quad core processor, ethernet control, a flow control module and recirculating chiller and vacuum pump with a heated vacuum platen with adjustable zones, along with an alignment vision module that may include a camera and corresponding lighting.

The subtractive manufacturing device 520 may be a machine that shapes objects by removing material from a larger piece rather than adding it, as in additive manufacturing. Thus, for example, the subtractive manufacturing device 520 may include tools for cutting, drilling, grinding, etc. The operator 90 may interact with the subtractive manufacturing device 520 (and/or the additive manufacturing device 510) via direct interaction or interaction indirectly via the AI manager 20. The AI manager 20 may, in some case, provide component or device specifications or instructions for fabrication of a part or device from the corresponding repair procedure stored in the documents agent 50.

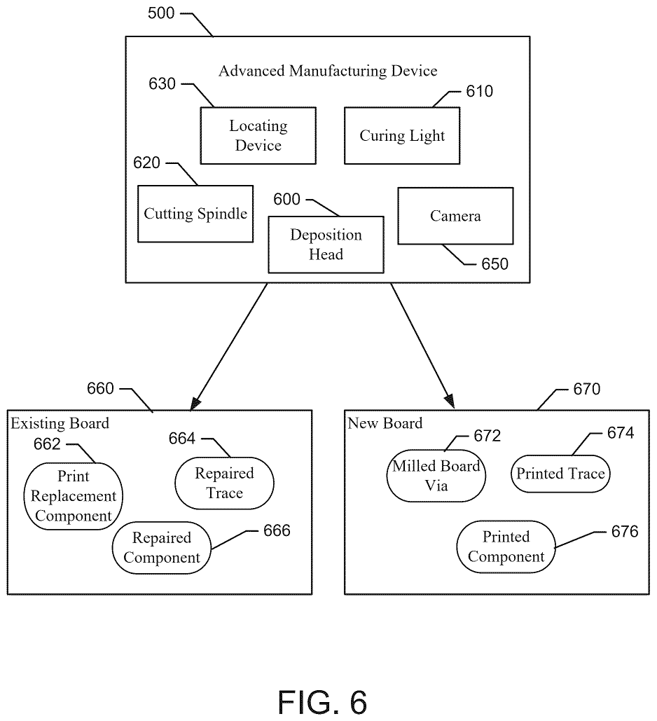

As noted above, in some cases, the additive manufacturing device 510 and the subtractive manufacturing device 520 may be integrated into a single device. FIG. 6 illustrates such an example. In the example of FIG. 6, parts of the advanced manufacturing device 500 that may be considered to be inclusive of the additive manufacturing device 510 may include the deposition head 600 and curing light 610 (or sintering device). The deposition head 600 may deposit material for additive manufacturing to build a part or device. Thus, for example, the deposition head 600 may direct the writing of conductive and insulating links with sub-50 micrometer feature sizes for small components and traces on PCBs. However, the deposition head 600 may also be used for other and larger parts and components that may be built in layers of various types of printing materials. The curing light 610 may be an ultraviolet or other light capable of providing in situ curing of printed dielectric inks or other substances. The curing light 610 may therefore enable high aspect ratio features and printed insulators to be provided over certain circuit components.

A cutting spindle 620 may be provided as a portion of the advanced manufacturing device 500 that may be considered to be inclusive of the subtractive manufacturing device 520. The cutting spindle 620 may, for example, be a spindle with a collet for cutting copper traces, removing solder masks and unmasking vias in a PCB context. However, the cutting spindle 620 may also be capable of removing materials including metals from larger parts as well.

A locating device 630 and a camera 650 may also be provided in some cases, and these components may not necessarily be specifically associated with either the additive manufacturing device 510 or the subtractive manufacturing device 520, and may actually be assistive to both such devices or portions. In this regard, the locating device 630 may include alignment and locating components for holding the part being manufactured and for location of circuit features and calibration of tool offsets using a global coordinate system. In some cases, the locating device 630 may include an alignment camera that assists in providing these locating features. Meanwhile the camera 650 may be a different camera with a different purpose. In this regard, the camera 650 may be used as a process camera that may provide real time monitoring of print processes, which may enable on the fly tuning of print parameters.

Although, as noted above, the advanced manufacturing device 500 may be used to fabricate components of various types and materials, when used to fabricate boards (e.g., PCBs), the advanced manufacturing device 500 may be useful in connection with defining repairs by either repairing an existing board 660 or by fabricating a new board 670. In relation to repairs on the existing board 660, the advanced manufacturing device 500 may provide an ability to print a replacement component 662, generate a repaired trace 664, or generate a repaired component 666. In some cases, a functionally similar device may be connected at a same or alternate location on the PCB. For example, if a USB port is broken off the PCB, a microUSB port may be added elsewhere, and traces may be run to complete connections to restore appropriate functionality. For the new board 670, the advanced manufacturing device 500 may provide an ability to generate a milled board via 672, one or more instances of a printed trace 674 and one or more instances of a printed component 676.

The repair processes that are driven by the AI manager 20 may be conducted by the operator 90 using augmented reality, as noted above (e.g., via the augmented reality engine 80). FIG. 7 illustrates some components of the augmented reality engine 80 in accordance with an example embodiment. In this regard, an augmented reality (AR) headset 700 may be provided to be worn by the operator 90. The AR headset 700 may include a vision system 710 (e.g., goggles) that may operate in conjunction with an XR interface 720 (e.g., a hololens) to facilitate interaction with a part or device under test using augmented reality. More particularly, the XR interface 720 may generate a mixed reality environment that blends digital elements (e.g., visible via the goggles) with elements of the real world (e.g., the part or device under test). The digital elements may be overlaid (or appear to be overlaid) on the part or device under test.

Meanwhile, the AR headset 700 may also include an audio system 730 that may include a microphone and/or a speaker system. The speaker system may provide audio into the ears of the operator 90 and the microphone may allow the operator 90 to speak to the AI manager 20 via the HMI module 70. Thus, the audio system 730 may enable real time conversation between the operator 90 and the AI manager 20 via a natural language processed system of prompts and responses driven by the operator 90. Accordingly, not only may the operator 90 be provided with guidance associated with conducting a repair, but the operator 90 may also interact with the AI manager 20 to report further observations, ask questions, or otherwise provide feedback or input relevant to the repair session being conducted.

In some cases, the operator 90 may also use a tool interface 740, which may also communicate with the HMI module 70 to, for example, integrate the tool being used into the AR environment being created. If employed, the tool interface 740 may facilitate locating or orienting the tool being used into the AR environment accurately relative to the real world object and any digital representations being presented.

In an example embodiment a session recorder 750 may also be provided in connection with the augmented reality engine 80. The session recorder 750 may be, for example, a video camera that may capture video of a repair session. Thus, not only the interaction between the operator 90 and the AI manager 20 in relation to performing the repair of the selected repair session may be recorded, but also the final result of the repair. Accordingly, to the extent a repair is performed with results that differ from standard practices, not only may the result be noted for the record, but another technician performing a later repair may reference the distinguished repair process to copy the earlier process. For example, if a repair procedure calls for welding a component, but welding is not an option due to equipment limitations or other reasons, an alternative may be employed such as, for example, bolting the component instead of welding it. The process for completing the repair using a bolting operation instead of a welding operation may be recorded and noted. Later access to the repair may be referenced if a subsequent fault detected in another similar device is encountered in a situation where welding cannot be used, or is otherwise undesirable. The technician in a later case can find in the repair in the earlier case that is annotated as having included an alternative (e.g., bolting) process. Thus, for example, if the operator 90 is executing a selected repair procedure 760, the repair session 762 that is performed by the operator 90 may be recorded and stored in association with the selected repair procedure 760 at the documents agent 50. The session recorder 750 is not limited to video recording however, In this regard, for example, the session recorder 750 may record actions the user takes via the AI manager 20, data obtained, and may provide a summary or after action report that provides a functional account of the actions taken during a session.

Although not required, in some cases, an access agent 790 may be provided to restrict access to various functions of the AR headset 700 (or AI manager 20 more generally). In such examples, the access agent 790 may be configured to receive entry criteria (e.g., identity information, access level criteria, etc.) defining an interaction level of the operator with the AI manager 20. Thus, for example, junior technicians may be limited to certain interactions or activities, whereas more senior technicians or supervisors may only access other interactions or activities (e.g., ordering expensive parts, etc.).

Thus, according to some example embodiments, a system for providing agentic AI-assisted troubleshooting or repair may be provided. The system may include a documents agent including storage for a plurality of repair procedures and the ability to retrieve the information on demand, an AI manager including a state machine defining a plurality of states through which diagnostic processes relating to the troubleshooting or repair are managed in relation to a selected repair procedure among the plurality of repair procedures, a data analytics agent including a Bayesian Network model that produces an assessment, an AI agent including one or more AI models, and an AI manager including a HMI module configured to enable an operator to interface with the data analytics agent via natural language interaction with the AI agent to drive a process for the troubleshooting or repair of a device associated with the selected repair procedure.

In some embodiments, the features or operations of the system described above may be augmented or modified, or additional features or operations may be added. These augmentations, modifications and additions may be optional and may be provided in any combination. Thus, although some example modifications, augmentations and additions are listed below, it should be appreciated that any of the modifications, augmentations and additions could be implemented individually or in combination with one or more, or even all of the other modifications, augmentations and additions that are listed. As such, for example, one or more of the AI agent, the data analytics agent, and the documents agent may be operably coupled to the AI manager via a network connection. In an example embodiment, the network connection may be a wireless connection including a cellular network or a satellite network. In some cases, the AI agent, the data analytics agent, and the documents agent may each be collocated with the AI manager on a ship. In an example embodiment, the data analytics agent may include a Bayesian network model relating faults to observations for each of the plurality of repair procedures. In some cases, the HMI module may include an output terminal, a command line interface or an augmented reality engine. In an example embodiment, the augmented reality engine may include an augmented reality headset configured to overlay holographic guidance instructions relative to the device during a repair activity guided by the AI manager. In some cases, the system may further include a session recorder configured to record data associated with the operator repairing the device during the repair activity as a repair session. In such cases, the repair session may be stored in association with the selected repair procedure at the documents agent. In an example embodiment, the state machine may include an observation state during which the natural language interaction with the operator guides the operator through troubleshooting steps associated with the selected repair procedure, a repair state during which the natural language interaction with the operator guides the operator through repair steps associated with the selected repair procedure, and a validation state via which success of a repair of the device is confirmed and, responsive to confirmation of the success of the repair, the state machine transitions to a summary state, responsive to an indeterminate situation the state machine transitions to the observation state, and responsive to not confirming the success of the repair, the state machine transitions to the repair state. In some cases, the state machine may further include a summary state via which the AI agent provides a summary of the repair responsive to the confirmation of the success of the repair. In an example embodiment, the AI manager may include processing circuitry configured to determine when a fault has been identified with a fault confidence level exceeding a predetermined threshold in the observation state and transitions from the observation state to the repair state responsive to determining the fault has been identified with the fault confidence level exceeding the predetermined threshold. In some cases, the AI manager may select the selected repair procedure based on the fault, and the processing circuitry may be further configured to determine when the repair is completed with a repair confidence level exceeding a predetermined confidence threshold in the repair state and transitions from the repair state to the validation state responsive to determining the repair has been completed with the repair confidence level exceeding the predetermined confidence threshold. In an example embodiment, the HMI module may be operably coupled to an advanced manufacturing device configured to fabricate or repair a component of the device. In some cases, the advanced manufacturing device may include an additive manufacturing device and/or a subtractive manufacturing device. In an example embodiment, the advanced manufacturing device may be configured to perform electronics advanced manufacturing operations including printing a component on a new printed circuit board (PCB) or an existing PCB, milling board vias on the new PCB, printing traces on the new PCB, repairing a component on the existing PCB, and repairing a trace on the existing PCB. In an example embodiment, the advanced manufacturing device may include a deposition head for additive manufacture of at least a portion of the component, a curing light for curing materials used for the additive manufacture, a locating device for aligning locations of features of the component, a cutting spindle for subtractive manufacture of another portion of the component, and a camera for real time monitoring of the advanced manufacturing device.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

What is claimed is:

1. A system for providing agentic artificial intelligence (AI)-assisted complex processing, troubleshooting or repair, the system comprising:
a documents agent comprising storage for a plurality of repair procedures;
an AI manager comprising a state machine defining a plurality of states through which diagnostic processes relating to the troubleshooting or repair are managed in relation to a selected repair procedure among the plurality of repair procedures;
a data analytics agent comprising a Bayesian Network model that produces an assessment;
an AI agent comprising one or more AI models; and
an AI manager comprising a human machine interface (HMI) module configured to enable an operator to interface with the data analytics agent via natural language interaction with the AI agent to drive a process for the troubleshooting or repair of a device associated with the selected repair procedure.

2. The system of claim 1, wherein one or more of the AI agent, the data analytics agent, and the documents agent is operably coupled to the AI manager via a network connection.

3. The system of claim 2, wherein the network connection is a wireless connection including a cellular network, cloud network or a satellite network.

4. The system of claim 1, wherein the AI agent, the data analytics agent, and the documents agent are each collocated with the AI manager on a stand-alone platform, entity, facility or a ship.

5. The system of claim 1, wherein the data analytics agent comprises a Bayesian network model relating faults to observations for each of the plurality of repair procedures.

6. The system of claim 1, wherein the HMI module comprises an output terminal, a command line interface or an augmented reality engine.

7. The system of claim 6, wherein the augmented reality engine comprises an augmented reality headset configured to overlay holographic guidance instructions relative to the device during a complex process or repair activity guided by the AI manager.

8. The system of claim 7, further comprising a session recorder configured to record data associated with the operator repairing the device during the repair activity as a repair session,
wherein the repair session is stored in association with the selected repair procedure at the documents agent.

9. The system of claim 1, wherein the state machine includes:
an observation state during which the natural language interaction with the operator guides the operator through troubleshooting steps associated with the selected repair procedure;
a repair state during which the natural language interaction with the operator guides the operator through repair steps associated with the selected repair procedure; and
a validation state via which success of a repair of the device is confirmed and, responsive to confirmation of the success of the repair, a state machine transitions to a summary state, responsive to an indeterminate situation the state machine transitions to the observation state, and responsive to not confirming the success of the repair, the state machine transitions to the repair state.

10. The system of claim 9, wherein the state machine further includes a summary state via which the AI agent provides a summary of the repair responsive to the confirmation of the success of the repair.

11. The system of claim 9, wherein the AI manager comprises processing circuitry configured to determine when a fault has been identified with a fault confidence level exceeding a predetermined threshold in the observation state and transitions from the observation state to the repair state responsive to determining the fault has been identified with the fault confidence level exceeding the predetermined threshold.

12. The system of claim 11, wherein the AI manager selects the selected repair procedure based on the fault,
wherein the processing circuitry is further configured to determine when the repair is completed with a repair confidence level exceeding a predetermined confidence threshold in the repair state and transitions from the repair state to the validation state responsive to determining the repair has been completed with the repair confidence level exceeding the predetermined confidence threshold.

13. The system of claim 1, wherein the HMI module is operably coupled to an advanced manufacturing device configured to fabricate or repair a component of the device.

14. The system of claim 13, wherein the advanced manufacturing device comprises an additive manufacturing device.

15. The system of claim 14, wherein the advanced manufacturing device further comprises a subtractive manufacturing device.

16. The system of claim 13, wherein the HMI module is operably coupled to an external website or procurement agent to facilitate ordering of the component of the device.

17. The system of claim 13, wherein the advanced manufacturing device is configured to perform electronics advanced manufacturing operations including:
printing a component on a new printed circuit board (PCB) or an existing PCB;
milling board vias on the new PCB;
printing traces on the new PCB;
repairing or replacing a component on the existing PCB; and
repairing a trace on the existing PCB.

18. The system of claim 13, wherein the advanced manufacturing device comprises:
a deposition head for additive manufacture of at least a portion of the component;
a curing light or sintering device for curing materials or sintering materials used for the additive manufacture;
a locating device for aligning locations of features of the component;
a cutting spindle for subtractive manufacture of another portion of the component; and
a camera for real time monitoring of the advanced manufacturing device.

19. An artificial intelligence (AI) manager for providing agentic AI-assisted troubleshooting or repair, the AI manager comprising:
a human machine interface (HMI) module;
processing circuitry including a processor and memory and configured to interface with a documents agent comprising storage for a plurality of repair procedures, a state machine defining a plurality of states through which diagnostic processes relating to the troubleshooting or repair are managed in relation to a selected repair procedure among the plurality of repair procedures, and an AI agent comprising one or more AI models; and
an interface to an external application programming interface (API) to enable connection to one or more external agents,
wherein the HMI module is configured to enable an operator or group of operators to interface with a data analytics agent via natural language interaction over audio, visual or textual interfaces with the AI agent to drive a process for the troubleshooting or repair of a device associated with the selected repair procedure.

20. The AI manager of claim 19, wherein the state machine includes:
an observation state during which the natural language interaction with the operator guides the operator through troubleshooting steps associated with the selected repair procedure;
a repair state during which the natural language interaction with the operator guides the operator through repair steps associated with the selected repair procedure; and
a validation state via which success of a repair of the device is confirmed and, responsive to confirmation of the success of the repair, a state machine transitions to a summary state, responsive to an indeterminate situation the state machine transitions to the observation state, and responsive to not confirming the success of the repair, the state machine transitions to the repair state.

21. The AI manager of claim 19, wherein the HMI module is operably coupled to an advanced manufacturing device configured to fabricate or repair a component of the device using one or both of additive manufacturing and subtractive manufacturing.

22. The AI manager of claim 19, further comprising an access agent configured to receive entry criteria defining an interaction level of the operator with the AI manager.

23. The AI manager of claim 19, further comprising one or more additional agents or human machine interfaces network connected to the AI manager via internet, cloud or satellite interfaces.
